(19) United States
(12) Patent Application Publication
(10) Pub. No.: US 2022/0187843 A1
(43) Pub. Date: Jun. 16, 2022

(54) SYSTEMS AND METHODS FOR CALIBRATING AN INERTIAL MEASUREMENT UNIT AND A CAMERA

(71) Applicant: BEIJING VOYAGER TECHNOLOGY CO., LTD., Beijing (CN)

(72) Inventor: Zhen WANG, Beijing (CN)

(73) Assignee: BEIJING VOYAGER TECHNOLOGY CO., LTD., Beijing (CN)

(21) Appl. No.: 17/653,453

(22) Filed: Mar. 3, 2022

Related U.S. Application Data
(63) Continuation of application No. PCT/CN2019/107171, filed on Sep. 23, 2019.

(51) Int. Cl. G05D 1/02; G06T 7/80

(52) U.S. Cl. CPC G05D 1/0246; G06T 2207/30252; G05D 2201/0213; G06T 7/80

(57) ABSTRACT

The present disclosure relates to a system and a method for calibrating an inertial measurement unit (IMU) and a camera of an autonomous vehicle. The system may perform the method to: obtain a track of the autonomous vehicle traveling straight; determine an IMU pose of the IMU relative to a first coordinate system; determine a camera pose of the camera relative to a second coordinate system; determine a relative coordinate pose between the first coordinate system and the second coordinate system; and determine a relative pose between the camera and the IMU based on the IMU pose, the camera pose, and the relative coordinate pose.

### CROSS-REFERENCE TO THE RELATED APPLICATIONS

This application is a continuation of International Application No. PCT/CN2019/107171, filed on Sep. 23, 2019, the contents of which are hereby incorporated by reference.

### TECHNICAL FIELD

This present disclosure generally relates to systems and methods for autonomous driving, and in particular, to systems and methods for calibrating an inertial measurement unit (IMU) and a camera of an autonomous vehicle.

### BACKGROUND

Autonomous vehicles, combining a variety of sensors, have become increasingly popular. An onboard IMU and camera play important roles in driving automation. However, in some situations, the calibration between the IMU and the camera is complicated, or in an indirect manner. Therefore, it is desirable to provide systems and methods for calibrating the IMU and the camera in a simple and direct way.

### SUMMARY

An aspect of the present disclosure introduces a system for calibrating an IMU and a camera of an autonomous vehicle. The system may include at least one storage medium including a set of instructions for calibrating the IMU and the camera; and at least one processor in communication with the storage medium, wherein when executing the set of instructions, the at least one processor is directed to: obtain a track of the autonomous vehicle traveling straight; determine an IMU pose of the IMU relative to a first coordinate system; determine a camera pose of the camera relative to a second coordinate system; determine a relative coordinate pose between the first coordinate system and the second coordinate system; and determine a relative pose between the camera and the IMU based on the IMU pose, the camera pose, and the relative coordinate pose.

In some embodiments, the at least one processor is further directed to: determine the first coordinate system based on the track of the autonomous vehicle.

In some embodiments, to determine the IMU pose, the at least one processor is further directed to: obtain IMU data from the IMU; and determine the IMU pose based on the IMU data and the first coordinate system.

In some embodiments, the at least one processor is further directed to: obtain camera data from the camera; and determine the second coordinate system based on camera data.

In some embodiments, to determine the camera pose, the at least one processor is further directed to: determine the camera pose based on the camera data and the second coordinate system.

In some embodiments, to determine the second coordinate system, the at least one processor is further directed to: determine a second ground normal vector based on the camera data and a 3D reconstruction method; determine a second travelling direction of the camera based on the camera data; and determine the second coordinate system based on the second ground normal vector and the second travelling direction of the camera.

In some embodiments, the 3D reconstruction method is a Structure from Motion (SFM) method.

In some embodiments, to determine the relative coordinate pose, the at least one processor is further directed to: align a first ground normal vector of the first coordinate system with the second ground normal vector of the second coordinate system; align a first travelling direction of the IMU with the second travelling direction of the camera; and determine the relative coordinate pose between the first coordinate system and the second coordinate system.

According to another aspect of the present disclosure, a method for calibrating an IMU and a camera of an autonomous vehicle. The method may include obtaining a track of the autonomous vehicle traveling straight; determining an IMU pose of the IMU relative to a first coordinate system; determining a camera pose of the camera relative to a second coordinate system; determining a relative coordinate pose between the first coordinate system and the second coordinate system; and determining a relative pose between the camera and the IMU based on the IMU pose, the camera pose, and the relative coordinate pose.

According to still another aspect of the present disclosure, a non-transitory computer-readable medium, comprising at least one set of instructions compatible for calibrating an IMU and a camera of an autonomous vehicle. When executed by at least one processor of an electrical device, the at least one set of instructions directs the at least one processor to perform a method. The method may include obtaining a track of the autonomous vehicle traveling straight; determining an IMU pose of the IMU relative to a first coordinate system; determining a camera pose of the camera relative to a second coordinate system; determining a relative coordinate pose between the first coordinate system and the second coordinate system; and determining a relative pose between the camera and the IMU based on the IMU pose, the camera pose, and the relative coordinate pose.

According to still another aspect of the present disclosure, a system for calibrating an IMU and a camera of an autonomous vehicle may include a track obtaining module, configured to obtain a track of the autonomous vehicle traveling straight; an IMU pose determining module, configured to determine an IMU pose of the IMU relative to a first coordinate system; a camera pose determining module, configured to determine a camera pose of the camera relative to a second coordinate system; a relative coordinate pose determining module, configured to determine a relative coordinate pose between the first coordinate system and the second coordinate system; and a relative pose determining module, configured to determine a relative pose between the camera and the IMU based on the IMU pose, the camera pose, and the relative coordinate pose.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities, and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. The drawings are not to scale. These embodiments are non-limiting schematic embodiments, in which like reference numerals represent similar structures throughout the several views of the drawings, and wherein:

FIG. 1 is a schematic diagram illustrating an exemplary autonomous driving system according to some embodiments of the present disclosure;

FIG. 2 is a schematic diagram illustrating exemplary hardware and/or software components of an exemplary computing device according to some embodiments of the present disclosure;

FIG. 3 is a schematic diagram illustrating exemplary hardware and/or software components of an exemplary mobile device on which a terminal device may be implemented according to some embodiments of the present disclosure;

FIG. 4 is a block diagram illustrating an exemplary processing device according to some embodiments of the present disclosure;

FIG. 5 is a flowchart illustrating an exemplary process for calibrating an IMU and a camera of an autonomous vehicle according to some embodiments of the present disclosure;

FIG. 6 is a schematic diagram illustrating exemplary a relative pose between a camera and an IMU according to some embodiments of the present disclosure;

FIG. 7 is a flowchart illustrating an exemplary process for determining an IMU pose of an IMU relative to a first coordinate system according to some embodiments of the present disclosure;

FIG. 8 is a flowchart illustrating an exemplary process for determining a camera pose of a camera relative to a second coordinate system according to some embodiments of the present disclosure;

FIG. 9 is a flowchart illustrating an exemplary process for determining the second coordinate system according to some embodiments of the present disclosure; and

FIG. 10 is a flowchart illustrating an exemplary process for determining a relative coordinate pose between the first coordinate system and the second coordinate system according to some embodiments of the present disclosure.

### DETAILED DESCRIPTION

The following description is presented to enable any person skilled in the art to make and use the present disclosure, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but is to be accorded the widest scope consistent with the claims.

The terminology used herein is for the purpose of describing particular embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this disclosure, specify the presence of stated features, integers, steps, operations, elements, and/or components, but do not preclude the presence or addition of one or more other features, integers, steps, operations, elements, components, and/or groups thereof.

These and other features, and characteristics of the present disclosure, as well as the methods of operations and functions of the related elements of structure and the combination of parts and economies of manufacture, may become more apparent upon consideration of the following description with reference to the accompanying drawings, all of which form part of this disclosure. It is to be expressly understood, however, that the drawings are for the purpose of illustration and description only and are not intended to limit the scope of the present disclosure. It is understood that the drawings are not to scale.

The flowcharts used in the present disclosure illustrate operations that systems implement according to some embodiments of the present disclosure. It is to be expressly understood, the operations of the flowcharts may be implemented not in order. Conversely, the operations may be implemented in inverted order, or simultaneously. Moreover, one or more other operations may be added to the flowcharts. One or more operations may be removed from the flowcharts.

Moreover, while the systems and methods disclosed in the present disclosure are described primarily regarding calibrating an IMU and a camera in an autonomous driving system, it should be understood that this is only one exemplary embodiment. The systems and methods of the present disclosure may be applied to any other kind of transportation system. For example, the systems and methods of the present disclosure may be applied to transportation systems of different environments including land, ocean, aerospace, or the like, or any combination thereof. The autonomous vehicle of the transportation systems may include a taxi, a private car, a hitch, a bus, a train, a bullet train, a high-speed rail, a subway, a vessel, an aircraft, a spaceship, a hot-air balloon, or the like, or any combination thereof.

An aspect of the present disclosure relates to systems and methods for calibrating an IMU and a camera of an autonomous vehicle. The systems and methods may define two coordinate systems when the autonomous vehicle travelling straight. One coordinate system is used for determining a pose of the IMU, and another coordinate system is used for determining a pose of the camera. Although the pose of the IMU and the pose of the camera are in two different coordinate systems, the systems and methods may determine a relative pose of the two coordinate systems. In this way, the systems and methods may determine a relative pose between the IMU and the camera to calibrate them.

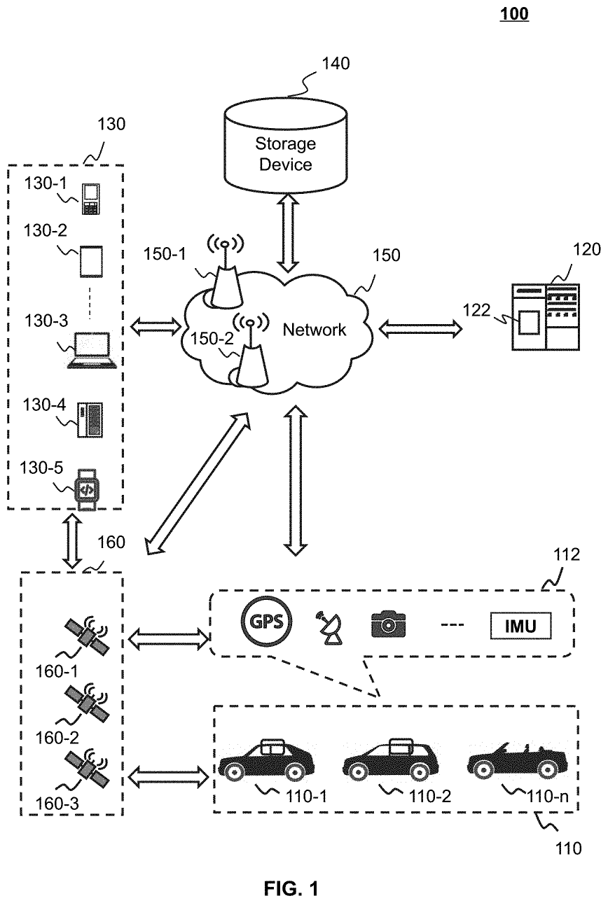

FIG. 1 is a schematic diagram illustrating an exemplary autonomous driving system 100 according to some embodiments of the present disclosure. In some embodiments, the autonomous driving system 100 may include a vehicle 110 (e.g. vehicle 110-1, 110-2 . . . and/or 110-n), a server 120, a terminal device 130, a storage device 140, a network 150, and a positioning and navigation system 160.

The vehicle 110 may be any type of autonomous vehicles, unmanned aerial vehicles, etc. An autonomous vehicle or unmanned aerial vehicle may refer to a vehicle that is capable of achieving a certain level of driving automation. Exemplary levels of driving automation may include a first level at which the vehicle is mainly supervised by a human and has a specific autonomous function (e.g., autonomous steering or accelerating), a second level at which the vehicle has one or more advanced driver assistance systems (ADAS) (e.g., an adaptive cruise control system, a lane-keep system) that can control the braking, steering, and/or acceleration of the vehicle, a third level at which the vehicle is able to drive autonomously when one or more certain conditions are met, a fourth level at which the vehicle can operate without human input or oversight but still is subject to some constraints (e.g., be confined to a certain area), a fifth level at which the vehicle can operate autonomously under all circumstances, or the like, or any combination thereof.

In some embodiments, the vehicle 110 may have equivalent structures that enable the vehicle 110 to move around or fly. For example, the vehicle 110 may include structures of a conventional vehicle, for example, a chassis, a suspension, a steering device (e.g., a steering wheel), a brake device (e.g., a brake pedal), an accelerator, etc. As another example, the vehicle 110 may have a body and at least one wheel. The body may be any body style, such as a sports vehicle, a coupe, a sedan, a pick-up truck, a station wagon, a sports utility vehicle (SUV), a minivan, or a conversion van. The at least one wheel may be configured to as all-wheel drive (AWD), front wheel drive (FWR), rear wheel drive (RWD), etc. In some embodiments, it is contemplated that vehicle 110 may be an electric vehicle, a fuel cell vehicle, a hybrid vehicle, a conventional internal combustion engine vehicle, etc.

In some embodiments, the vehicle 110 may be capable of sensing its environment and navigating with one or more detecting units 112. The plurality of detection units 112 may include a global position system (GPS) module, a radar (e.g., a light detection and ranging (LiDAR)), an inertial measurement unit (IMU), a camera, or the like, or any combination thereof. The radar (e.g., LiDAR) may be configured to scan the surrounding and generate point-cloud data. The point-cloud data then may be used to make digital 3-D representations of one or more objects surrounding the vehicle 110. The GPS module may refer to a device that is capable of receiving geolocation and time information from GPS satellites and then to calculate the device's geographical position. The IMU sensor may refer to an electronic device that measures and provides a vehicle's specific force, an angular rate, and sometimes the magnetic field surrounding the vehicle, using various inertial sensors. The various inertial sensors may include an acceleration sensor (e.g., a piezoelectric sensor), a velocity sensor (e.g., a Hall sensor), a distance sensor (e.g., a radar, a LIDAR, an infrared sensor), a steering angle sensor (e.g., a tilt sensor), a traction-related sensor (e.g., a force sensor), etc. The camera may be configured to obtain one or more images relating to objects (e.g., a person, an animal, a tree, a roadblock, a building, or a vehicle) that are within the scope of the camera.

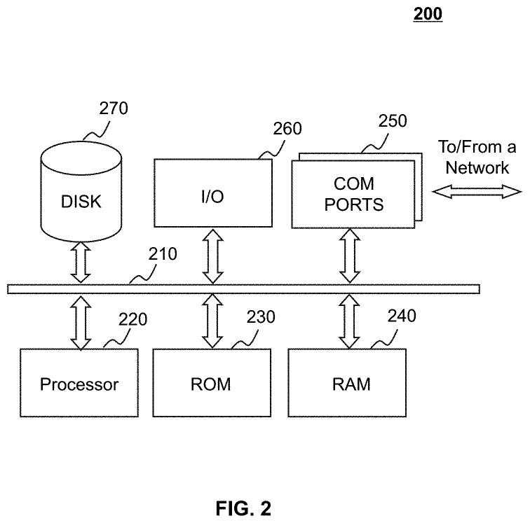

In some embodiments, the server 120 may be a single server or a server group. The server group may be centralized or distributed (e.g., the server 120 may be a distributed system). In some embodiments, the server 120 may be local or remote. For example, the server 120 may access information and/or data stored in the terminal device 130, the detecting units 112, the vehicle 110, the storage device 140, and/or the positioning and navigation system 160 via the network 150. As another example, the server 120 may be directly connected to the terminal device 130, the detecting units 112, the vehicle 110, and/or the storage device 140 to access stored information and/or data. In some embodiments, the server 120 may be implemented on a cloud platform or an onboard computer. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 120 may be implemented on a computing device 200 having one or more components illustrated in FIG. 2 in the present disclosure.

In some embodiments, the server 120 may include a processing device 122. The processing device 122 may process information and/or data associated with autonomous driving to perform one or more functions described in the present disclosure. For example, the processing device 122 may calibrate the IMU and the camera. In some embodiments, the processing device 122 may include one or more processing engines (e.g., single-core processing engine(s) or multi-core processor(s)). Merely by way of example, the processing device 122 may include a central processing unit (CPU), an application-specific integrated circuit (ASIC), an application-specific instruction-set processor (ASIP), a graphics processing unit (GPU), a physics processing unit (PPU), a digital signal processor (DSP), a field programmable gate array (FPGA), a programmable logic device (PLD), a controller, a microcontroller unit, a reduced instruction-set computer (RISC), a microprocessor, or the like, or any combination thereof. In some embodiments, the processing device 122 may be integrated into the vehicle 110 or the terminal device 130.

In some embodiments, the terminal device 130 may include a mobile device 130-1, a tablet computer 130-2, a laptop computer 130-3, a built-in device in a vehicle 130-4, a wearable device 130-5, or the like, or any combination thereof. In some embodiments, the mobile device 130-1 may include a smart home device, a wearable device, a smart mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a smart bracelet, a smart footgear, a smart glass, a smart helmet, a smart watch, smart clothing, a smart backpack, a smart accessory, or the like, or any combination thereof. In some embodiments, the smart mobile device may include a smartphone, a personal digital assistant (PDA), a gaming device, a navigation device, a point of sale (POS) device, or the like, or any combination thereof. In some embodiments, the virtual reality device and/or the augmented reality device may include a virtual reality helmet, a virtual reality glass, a virtual reality patch, an augmented reality helmet, an augmented reality glass, an augmented reality patch, or the like, or any combination thereof. For example, the virtual reality device and/or the augmented reality device may include a Google™ Glass, an Oculus Rift, a HoloLens, a Gear VR, etc. In some embodiments, the built-in device in the vehicle 130-4 may include an onboard computer, an onboard television, etc. In some embodiments, the server 120 may be integrated into the terminal device 130. In some embodiments, the terminal device 130 may be a device with positioning technology for locating the location of the terminal device 130.

The storage device 140 may store data and/or instructions. In some embodiments, the storage device 140 may store data obtained from the vehicle 110, the detecting units 112, the processing device 122, the terminal device 130, the positioning and navigation system 160, and/or an external storage device. For example, the storage device 140 may store IMU data obtained from the IMU in the detecting units 112. As another example, the storage device 140 may store camera data obtained from the camera in the detecting units 112. In some embodiments, the storage device 140 may store data and/or instructions that the server 120 may execute or use to perform exemplary methods described in the present disclosure. For example, the storage device 140 may store instructions that the processing device 122 may execute or use to calibrate the IMU and the camera. In some embodiments, the storage device 140 may include a mass storage, a removable storage, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyrisor RAM (T-RAM), and a zero-capacitor RAM (Z-RAM), etc. Exemplary ROM may include a mask ROM (MROM), a programmable ROM (PROM), an erasable programmable ROM (EPROM), an electrically-erasable programmable ROM (EEPROM), a compact disk ROM (CD-ROM), and a digital versatile disk ROM, etc. In some embodiments, the storage device 140 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage device 140 may be connected to the network 150 to communicate with one or more components (e.g., the server 120, the terminal device 130, the detecting units 112, the vehicle 110, and/or the positioning and navigation system 160) of the autonomous driving system 100. One or more components of the autonomous driving system 100 may access the data or instructions stored in the storage device 140 via the network 150. In some embodiments, the storage device 140 may be directly connected to or communicate with one or more components (e.g., the server 120, the terminal device 130, the detecting units 112, the vehicle 110, and/or the positioning and navigation system 160) of the autonomous driving system 100. In some embodiments, the storage device 140 may be part of the server 120. In some embodiments, the storage device 140 may be integrated into the vehicle 110.

The network 150 may facilitate exchange of information and/or data. In some embodiments, one or more components (e.g., the server 120, the terminal device 130, the detecting units 112, the vehicle 110, the storage device 140, or the positioning and navigation system 160) of the autonomous driving system 100 may send information and/or data to other component(s) of the autonomous driving system 100 via the network 150. For example, the server 120 may obtain IMU data or camera data from the vehicle 110, the terminal device 130, the storage device 140, and/or the positioning and navigation system 160 via the network 150. In some embodiments, the network 150 may be any type of wired or wireless network, or combination thereof. Merely by way of example, the network 150 may include a cable network, a wireline network, an optical fiber network, a tele communications network, an intranet, an Internet, a local area network (LAN), a wide area network (WAN), a wireless local area network (WLAN), a metropolitan area network (MAN), a wide area network (WAN), a public telephone switched network (PSTN), a Bluetooth network, a ZigBee network, a near field communication (NFC) network, or the like, or any combination thereof. In some embodiments, the network 150 may include one or more network access points. For example, the network 150 may include wired or wireless network access points (e.g., 150-1, 150-2), through which one or more components of the autonomous driving system 100 may be connected to the network 150 to exchange data and/or information.

The positioning and navigation system 160 may determine information associated with an object, for example, the terminal device 130, the vehicle 110, etc. In some embodiments, the positioning and navigation system 160 may include a global positioning system (GPS), a global navigation satellite system (GLONASS), a compass navigation system (COMPASS), a BeiDou navigation satellite system, a Galileo positioning system, a quasi-zenith satellite system (QZSS), etc. The information may include a location, an elevation, a velocity, or an acceleration of the object, a current time, etc. The positioning and navigation system 160 may include one or more satellites, for example, a satellite 160-1, a satellite 160-2, and a satellite 160-3. The satellites 160-1 through 160-3 may determine the information mentioned above independently or jointly. The satellite positioning and navigation system 160 may send the information mentioned above to the network 150, the terminal device 130, or the vehicle 110 via wireless connections.

One of ordinary skill in the art would understand that when an element (or component) of the autonomous driving system 100 performs, the element may perform through electrical signals and/or electromagnetic signals. For example, when the terminal device 130 transmits out a request to the server 120, a processor of the terminal device 130 may generate an electrical signal encoding the request. The processor of the terminal device 130 may then transmit the electrical signal to an output port. If the terminal device 130 communicates with the server 120 via a wired network, the output port may be physically connected to a cable, which further may transmit the electrical signal to an input port of the server 120. If the terminal device 130 communicates with the server 120 via a wireless network, the output port of the terminal device 130 may be one or more antennas, which convert the electrical signal to an electromagnetic signal. Within an electronic device, such as the terminal device 130 and/or the server 120, when a processor thereof processes an instruction, transmits out an instruction, and/or performs an action, the instruction and/or action is conducted via electrical signals. For example, when the processor retrieves or saves data from a storage medium (e.g., the storage device 140), it may transmit out electrical signals to a read/write device of the storage medium, which may read or write structured data in the storage medium. The structured data may be transmitted to the processor in the form of electrical signals via a bus of the electronic device. Here, an electrical signal may refer to one electrical signal, a series of electrical signals, and/or a plurality of discrete electrical signals.

FIG. 2 is a schematic diagram illustrating exemplary hardware and/or software components of an exemplary computing device according to some embodiments of the present disclosure. In some embodiments, the server 120 and/or the terminal device 130 may be implemented on the computing device 200. For example, the processing device 122 may be implemented on the computing device 200 and configured to perform functions of the processing device 122 disclosed in this disclosure.

The computing device 200 may be used to implement any component of the autonomous driving system 100 of the present disclosure. For example, the processing device 122 of the autonomous driving system 100 may be implemented on the computing device 200, via its hardware, software program, firmware, or a combination thereof. Although only one such computer is shown for convenience, the computer functions related to the autonomous driving system 100 as described herein may be implemented in a distributed manner on a number of similar platforms to distribute the processing load.

The computing device 200 may include communication (COM) ports 250 connected to and from a network (e.g., the network 150) connected thereto to facilitate data communications. The computing device 200 may also include a processor (e.g., a processor 220), in the form of one or more processors (e.g., logic circuits), for executing program instructions. For example, the processor may include interface circuits and processing circuits therein. The interface circuits may be configured to receive electronic signals from a bus 210, wherein the electronic signals encode structured data and/or instructions for the processing circuits to process. The processing circuits may conduct logic calculations, and then determine a conclusion, a result, and/or an instruction encoded as electronic signals. Then the interface circuits may send out the electronic signals from the processing circuits via the bus 210.

The computing device 200 may further include program storage and data storage of different forms, for example, a disk 270, and a read-only memory (ROM) 230, or a random access memory (RAM) 240, for various data files to be processed and/or transmitted by the computing device 200. The exemplary computing device 200 may also include program instructions stored in the ROM 230, the RAM 240, and/or another type of non-transitory storage medium to be executed by the processor 220. The methods and/or processes of the present disclosure may be implemented as the program instructions. The computing device 200 also includes an I/O component 260, supporting input/output between the computing device 200 and other components therein. The computing device 200 may also receive programming and data via network communications.

Merely for illustration, only one processor is described in the computing device 200. However, it should be noted that the computing device 200 in the present disclosure may also include multiple processors, and thus operations that are performed by one processor as described in the present disclosure may also be jointly or separately performed by the multiple processors. For example, the processor of the computing device 200 executes both operation A and operation B. As another example, operation A and operation B may also be performed by two different processors jointly or separately in the computing device 200 (e.g., the first processor executes operation A and the second processor executes operation B, or the first and second processors jointly execute operations A and B).

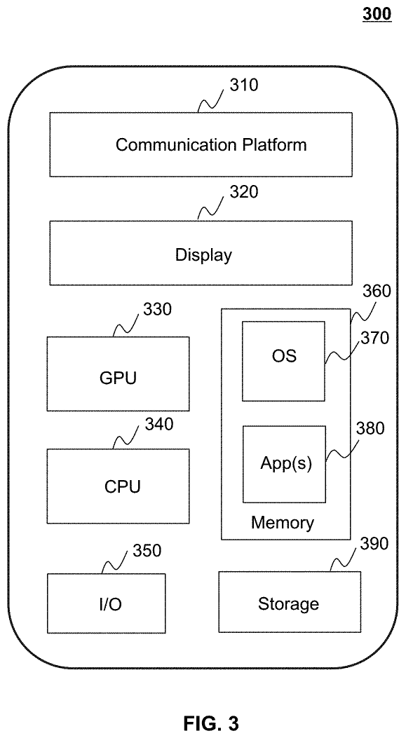

FIG. 3 is a schematic diagram illustrating exemplary hardware and/or software components of an exemplary mobile device on which a terminal device may be implemented according to some embodiments of the present disclosure. In some embodiments, the terminal device 130 may be implemented on the mobile device 300. As illustrated in FIG. 3, the mobile device 300 may include a communication platform 310, a display 320, a graphics processing unit (GPU) 330, a central processing unit (CPU) 340, an I/O 350, a memory 360, a mobile operating system (OS) 370, and storage 390. In some embodiments, any other suitable component, including but not limited to a system bus or a controller (not shown), may also be included in the mobile device 300.

In some embodiments, the mobile operating system 370 (e.g., iOS™, Android™, Windows Phone™) and one or more applications 380 may be loaded into the memory 360 from the storage 390 in order to be executed by the CPU 340. The applications 380 may include a browser or any other suitable mobile app for receiving and rendering information relating to positioning or other information from the processing device 122. User interactions with the information stream may be achieved via the I/O 350 and provided to the processing device 122 and/or other components of the autonomous driving system 100 via the network 150.

To implement various modules, units, and their functionalities described in the present disclosure, computer hardware platforms may be used as the hardware platform(s) for one or more of the elements described herein. A computer with user interface elements may be used to implement a personal computer (PC) or any other type of work station or terminal device. A computer may also act as a server if appropriately programmed.

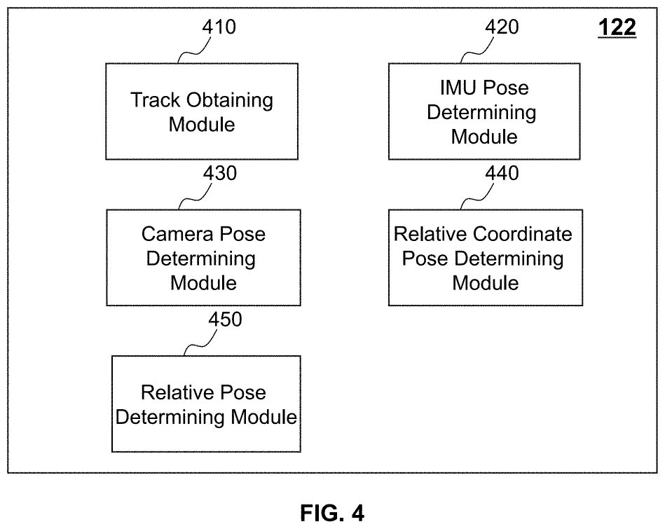

FIG. 4 is a block diagram illustrating an exemplary processing device 122 according to some embodiments of the present disclosure. The processing device 122 may include a track obtaining module 410, an IMU pose determining module 420, a camera pose determining module 430, a relative coordinate pose determining module 440, and a relative pose determining module 450.

The track obtaining module 410 may be configured to obtain a track of an autonomous vehicle traveling straight.

The IMU pose determining module 420 may be configured to determine an IMU pose of the IMU relative to a first coordinate system. For example, the IMU pose determining module 420 may obtain IMU data from the IMU, and determine the first coordinate system. As another example, the IMU pose determining module 420 may determine the IMU pose based on the IMU data and the first coordinate system.

The camera pose determining module 430 may be configured to determine a camera pose of the camera relative to a second coordinate system. For example, the camera pose determining module 430 may obtain camera data from the camera, and determine the second coordinate system based on the camera data. As another example, the camera pose determining module 430 may determine the camera pose based on the camera data and the second coordinate system.

The relative coordinate pose determining module 440 may be configured to determine a relative coordinate pose between the first coordinate system and the second coordinate system. For example, the relative coordinate pose determining module 440 may align the first ground normal vector of the first coordinate system with the second ground normal vector of the second coordinate system, and the first travelling direction of the IMU with the second travelling direction of the camera. The relative coordinate pose determining module 440 may further determine the relative coordinate pose between the first coordinate system and the second coordinate system.

The relative pose determining module 450 may be configured to determine a relative pose between the camera and the IMU based on the IMU pose, the camera pose, and the relative coordinate pose.

The modules in the processing device 122 may be connected to or communicate with each other via a wired connection or a wireless connection. The wired connection may include a metal cable, an optical cable, a hybrid cable, or the like, or any combination thereof. The wireless connection may include a Local Area Network (LAN), a Wide Area Network (WAN), a Bluetooth, a ZigBee, a Near Field Communication (NFC), or the like, or any combination thereof. Two or more of the modules may be combined as a single module, and any one of the modules may be divided into two or more units. For example, the processing device 122 may include a storage module (not shown) used to store information and/or data (e.g., the IMU data, the camera data, etc.) associated with calibrating the IMU and the camera.

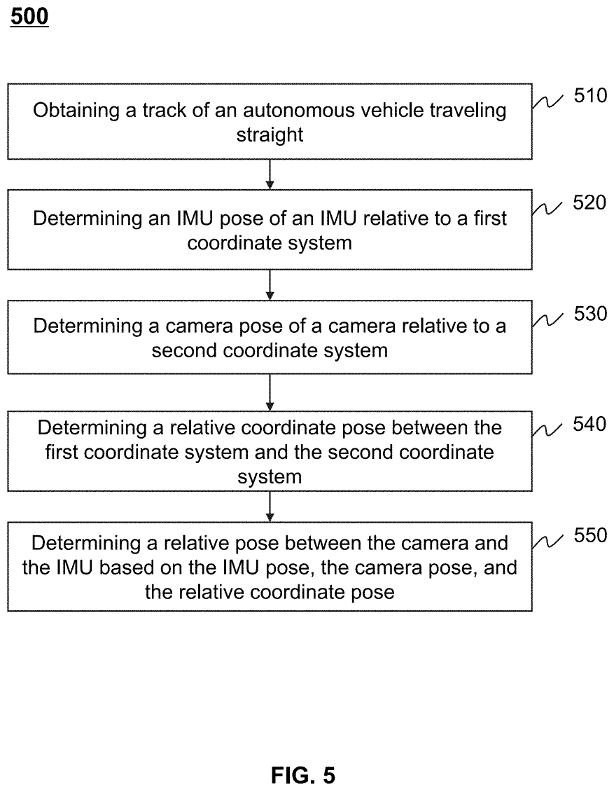

FIG. 5 is a flowchart illustrating an exemplary process 500 for calibrating an IMU and a camera of an autonomous vehicle according to some embodiments of the present disclosure. In some embodiments, the process 500 may be implemented as a set of instructions (e.g., an application) stored in the storage ROM 230 or RAM 240. The processor 220 and/or the modules in FIG. 4 may execute the set of instructions, and when executing the instructions, the processor 220 and/or the modules may be configured to perform the process 500. The operations of the illustrated process presented below are intended to be illustrative. In some embodiments, the process 500 may be accomplished with one or more additional operations not described and/or without one or more of the operations herein discussed. Additionally, the order in which the operations of the process as illustrated in FIG. 5 and described below is not intended to be limiting.

In 510, the processing device 122 (e.g., the track obtaining module 410, the interface circuits of the processor 220) may obtain a track of an autonomous vehicle traveling straight.

In some embodiments, an IMU and a camera may be mounted on the autonomous vehicle for sensing environment around the autonomous vehicle and navigating the autonomous vehicle. In some embodiments, the autonomous vehicle may be controlled (by a driver or the processing device 122) to travel straight for a predetermined distance. In some embodiments, the predetermined distance may be a default value stored in a storage device of the system 100 (e.g., the storage device 140, the ROM 230, the RAM 240, etc.), or determined by the system 100 or an operator thereof according to different application scenarios. For example, the predetermined distance may be 50 meters, 100 meters, 200 meters, 1000 meters, etc. The processing device 122 may obtain the track of the autonomous vehicle when the autonomous vehicle is travelling straight.

In 520, the processing device 122 (e.g., the IMU pose determining module 420) may determine an IMU pose of the IMU relative to a first coordinate system.

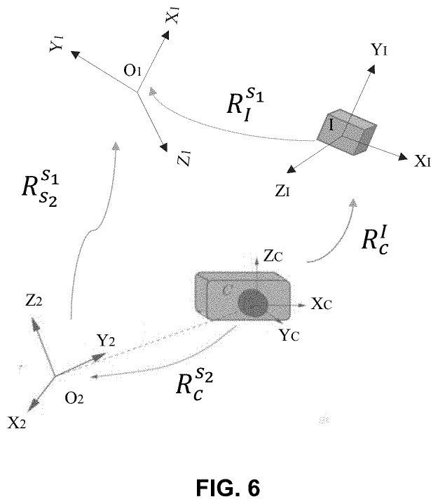

In some embodiments, the IMU pose relative to the first coordinate system may reflect an orientation, a position, an attitude, or a rotation of the IMU relative to the first coordinate system. In some embodiments, the IMU pose may be represented as an Euler angle, a Rotation matrix, an Orientation quaternion, or the like, or any combination thereof. For example, the IMU pose may be represented as a Rotation matrix R_{I}^{s}^{₁} as shown in FIG. 6, wherein R may represent a matrix, I may represent the IMU, and s₁ may represent the first coordinate system.

FIG. 6 is a schematic diagram illustrating exemplary relative pose between a camera and an IMU according to some embodiments of the present disclosure. As shown in FIG. 6, C may represent an origin of a camera, and X_{C}, Y_{C}, and Z_{C} may represent three axes of the camera, respectively. I may represent an origin of an IMU, and X_{I}, Y_{I}, and Z_{I} may represent three axes of the IMU, respectively. O₁ and O₂ may represent origins of a first coordinate system S₁ and a second coordinate system S₂, respectively. X₁, Y₁, and Z₁ may represent three axes of the first coordinate system S₁, respectively. X₂, Y₂, and Z₂ may represent three axes of the second coordinate system S₂, respectively. R_{C}^{I} may represent a relative pose of the camera relative to the IMU. R_{C}^{s}^{₂} may represent a relative pose of the camera relative to the second coordinate system S₂. R_{I}^{s}^{₁} may represent a relative pose of the IMU relative to the first coordinate system S₁. Rₛ_{₂}^{s}^{₁} may represent a relative pose of the second coordinate system S₂ relative to the first coordinate system S₁.

In some embodiments, the first coordinate system may be a defined 3D coordinate system. For example, when the autonomous vehicle is travelling straight, the processing device 122 may determine a first ground normal vector and a first travelling direction of the autonomous vehicle. The processing device 122 may determine the first coordinate system using the first ground normal vector and the first travelling direction as two axes of the first coordinate system according to a right-hand rule.

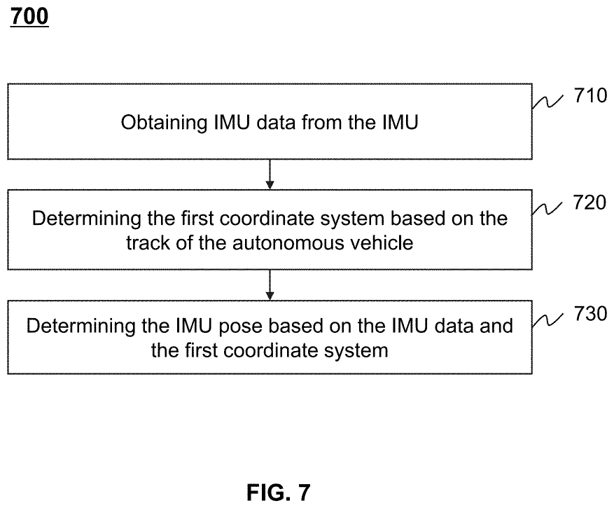

In some embodiments, when the autonomous vehicle is travelling straight, the IMU may detect and output an acceleration, a rotational rate, and sometimes a magnetic field around the IMU using various inertial sensors. For example, the various inertial sensors may include one or more accelerometers, one or more gyroscopes, one or more magnetometers, or the like, or any combination thereof. The processing device 122 may calculate the IMU pose using the acceleration, the rotational rate, and/or the magnetic field. The process or method for determining the first coordinate system and/or the IMU pose may be found elsewhere in the present disclosure (e.g., FIG. 7 and the descriptions thereof).

In 530, the processing device 122 (e.g., the camera pose determining module 430) may determine a camera pose of the camera relative to a second coordinate system.

In some embodiments, the camera pose relative to the second coordinate system may reflect an orientation, a position, an attitude, or a rotation of the camera relative to the second coordinate system. In some embodiments, the camera pose may be represented as an Euler angle, a Rotation matrix, an Orientation quaternion, or the like, or any combination thereof. For example, the camera pose may be represented as a Rotation matrix R_{c}^{s}^{₂} as shown in FIG. 6, wherein R may represent a matrix, R may represent the camera, and s₂ may represent the second coordinate system.

In some embodiments, the second coordinate system may be a defined 3D coordinate system associated with the camera. For example, when the autonomous vehicle is travelling straight, the camera may take videos or images within the scope of the camera. The processing device 122 may establish the second coordinate system based on the videos or images captured from the camera. For example, the processing device 122 may obtain a plurality of pictures from the videos or images, and process the plurality of pictures according to a 3D reconstruction method. The processing device 122 may obtain a second ground normal vector in the 3D scenario. The processing device 122 may determine the second coordinate system using the second ground normal vector and a second travelling direction of the camera as two axes of the second coordinate system according to a right-hand rule.

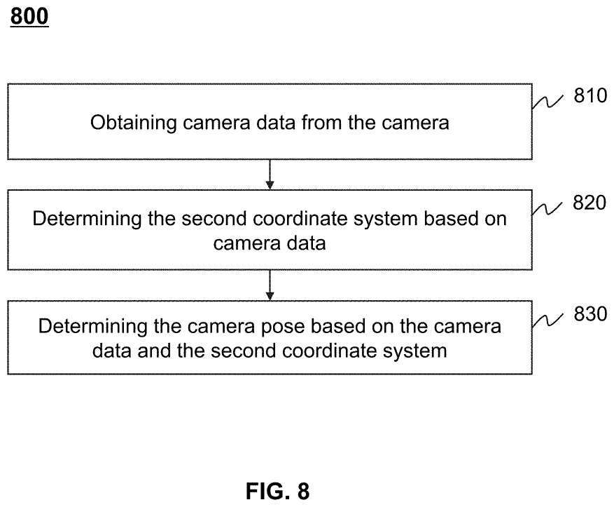

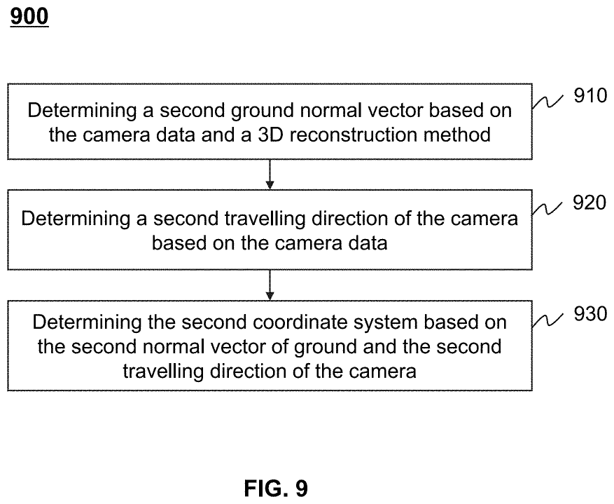

In some embodiments, the processing device 122 may determine the camera pose based on the 3D reconstruction method. For example, the processing device 122 may input the plurality of pictures and/or internal parameters of the camera into the 3D reconstruction method. The 3D reconstruction method may output the camera pose relative to the second coordinate system and 3D structural data of the scenario that the camera captured. The process or method for determining the second coordinate system and/or the camera pose may be found elsewhere in the present disclosure (e.g., FIGS. 8-9 and the descriptions thereof).

In 540, the processing device 122 (e.g., the relative coordinate pose determining module 440) may determine a relative coordinate pose between the first coordinate system and the second coordinate system.

In some embodiments, the relative coordinate pose between the first coordinate system and the second coordinate system may reflect an orientation, a position, an attitude, or a rotation of the first coordinate system relative to the second coordinate system. In some embodiments, the relative coordinate pose may be represented as an Euler angle, a Rotation matrix, an Orientation quaternion, or the like, or any combination thereof. For example, the relative coordinate pose may be represented as a Rotation matrix Rₛ_{ₛ}^{s}^{₂} as shown in FIG. 6, wherein R may represent a matrix, s₁ may represent the first coordinate system, and s₂ may represent the second coordinate system.

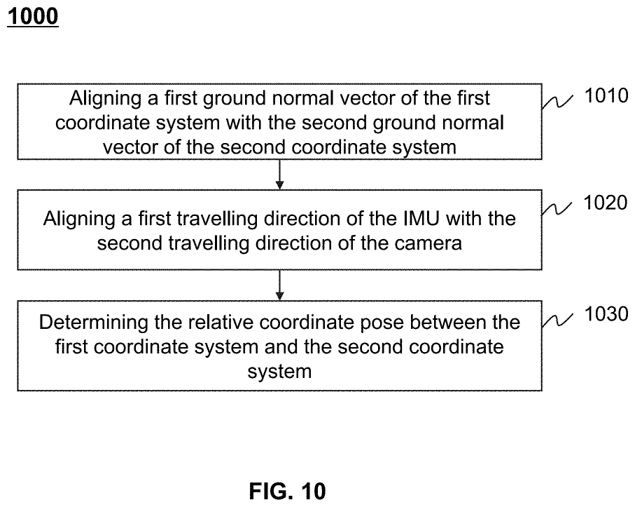

The first coordinate system and the second coordinate system are both defined coordinate systems, and essentially two different representations of a same coordinate system. In some embodiments, the processing device 122 may determine the relative coordinate pose by rotating and aligning the axes of the first coordinate system and the second coordinate system. For example, the processing device 122 may align the first ground normal vector of the first coordinate system and the second ground normal vector of the second coordinate system, and align the second travelling direction of the IMU and the second travelling direction of the camera around the ground normal vectors to determine the relative coordinate pose. In some embodiments, the processing device 122 may determine the relative coordinate pose based on a same reference coordinate system. For example, the processing device 122 may determine a first relative pose Rₛ_{₁}^{W} of the first coordinate system relative to a world coordinate system and a second relative pose R_{W}^{s}^{₂} of the world coordinate system relative to the second coordinate system, respectively. The processing device 122 may determine the relative coordinate pose Rₛ_{₁}^{s}^{₂} of the first coordinate system relative to the second coordinate system by multiplying the first relative pose Rₛ_{₁}^{W} by the second relative pose R_{W}^{s}^{₂}. The process or method for determining the relative coordinate pose may be found elsewhere in the present disclosure (e.g., FIG. 10 and the descriptions thereof).

In 550, the processing device 122 (e.g., the relative pose determining module 450) may determine a relative pose between the camera and the IMU based on the IMU pose, the camera pose, and the relative coordinate pose.

In some embodiments, the relative pose between the camera and the IMU may reflect an orientation, a position, an attitude, or a rotation of the camera relative to the IMU. In some embodiments, the relative pose may be represented as an Euler angle, a Rotation matrix, an Orientation quaternion, or the like, or any combination thereof. For example, the relative pose may be represented as Euler angles α, β, and γ. α, β, and γ may represent rotate angels around the X axis, Y axis, and Z axis, respectively. As another example, the relative pose may be represented as a Rotation matrix R_{C}^{I} as shown in FIG. 6, wherein R may represent a matrix, C may represent the camera, and I may represent the IMU. The Rotation matrix R_{C}^{I} may be a product of three rotation matrixes around three axes Rₓ, R_{Y}, and R_{Z}. Wherein

$${R}_{X} = [ \begin{matrix}1 & 0 & 0 \\ 0 & cos α & - s in α \\ 0 & sin α & cos α\end{matrix} ] , {R}_{Y} = [ \begin{matrix}cos β & 0 & sin β \\ 0 & 1 & 0 \\ - s in β & 0 & cos β\end{matrix} ] , {R}_{Z} = [ \begin{matrix}cos γ & - sin γ & 0 \\ sin γ & cos γ & 0 \\ 0 & 0 & 1\end{matrix} ] ,$$

and R_{C}^{I}=R_{X}×R_{Y}×R_{Z}.

In some embodiments, the processing device 122 may determine the relative pose R_{C}^{I} that is the camera pose relative to the IMU based on the IMU pose R_{I}^{s}^{₁}, the camera pose R_{c}^{s}^{₂}, and the relative coordinate pose Rₛ_{₁}^{s}^{₂}. For example, the processing device 122 may determine the relative pose R_{C}^{I} according to Equation (1) below:

R_{C}^{I}=Rₛ_{₁}^{I}×Rₛ_{₂}^{s}^{₁}×R_{c}^{s}^{₂} (1),

wherein Rₛ_{₂}^{s}^{₁} is a transposed matrix of the relative coordinate pose Rₛ_{₁}^{s}^{₂}, and Rₛ_{₁}^{I} is a transposed matrix of the IMU pose R_{I}^{s}^{₁}.

In some embodiments, the relative pose between the camera and the IMU may be used to navigate the autonomous vehicle. For example, when the autonomous vehicle is travelling, the processing device 122 may calculate a position where a 3D target that a Lidar of the autonomous vehicle obtained is located in the camera. With the help of the IMU, the processing device 122 may first transform the 3D target that the Lidar obtained into an IMU coordinate system, and then transform the 3D target into a camera coordinate system using the relative pose between the camera and the IMU.

It should be noted that the above description is merely provided for the purposes of illustration, and not intended to limit the scope of the present disclosure. For persons having ordinary skills in the art, multiple variations or modifications may be made under the teachings of the present disclosure. However, those variations and modifications do not depart from the scope of the present disclosure. For example, one or more other optional operations (e.g., a storing operation) may be added elsewhere in the process 500. In the storing operation, the processing device 122 may store information and/or data (e.g., the relative pose between the camera and the IMU) in a storage device (e.g., the storage device 140) disclosed elsewhere in the present disclosure.

FIG. 7 is a flowchart illustrating an exemplary process 700 for determining an IMU pose of an IMU relative to a first coordinate system according to some embodiments of the present disclosure. In some embodiments, the process 700 may be implemented as a set of instructions (e.g., an application) stored in the storage ROM 230 or RAM 240. The processor 220 and/or the modules in FIG. 4 may execute the set of instructions, and when executing the instructions, the processor 220 and/or the modules may be configured to perform the process 700. The operations of the illustrated process presented below are intended to be illustrative. In some embodiments, the process 700 may be accomplished with one or more additional operations not described and/or without one or more of the operations herein discussed. Additionally, the order in which the operations of the process as illustrated in FIG. 7 and described below is not intended to be limiting.

In 710, the processing device 122 (e.g., the IMU pose determining module 420, the interface circuits of the processor 220) may obtain IMU data from the IMU.

In some embodiments, the IMU may include a plurality of inertial sensors, such as one or more accelerometers, one or more gyroscopes, one or more magnetometers, or the like, or any combination thereof. The IMU may output the IMU data using the plurality of inertial sensors. For example, the IMU data may include an acceleration, a rotational rate, a magnetic field around the autonomous vehicle, or the like, or any combination thereof. The processing device 122 may obtain the IMU data from the IMU when the autonomous vehicle is travelling.

In 720, the processing device 122 (e.g., the IMU pose determining module 420) may determine the first coordinate system based on the track of the autonomous vehicle.

In some embodiments, when the autonomous vehicle is traveling straight, the processing device 122 may obtain the track of the autonomous vehicle. The processing device 122 may determine the first ground normal vector and the first travelling direction of the autonomous vehicle from the track of the autonomous vehicle. As shown in FIG. 6, the processing device 122 may use the first ground normal vector and the first travelling direction as two axes (e.g., the first ground normal vector as X₁ and the first travelling direction as Y₁) of the first coordinate system S₁, and determine the third axis (e.g., Z₁) of the first coordinate system S₁ according to a right-hand rule.

In 730, the processing device 122 (e.g., the IMU pose determining module 420) may determine the IMU pose based on the IMU data and the first coordinate system.

In some embodiments, the processing device 122 may calculate the IMU pose of the IMU relative to the first coordinate system based on the acceleration, the rotational rate, and/or the magnetic field around the autonomous vehicle. For example, the processing device 122 may fuse the acceleration, the rotational rate, and/or the magnetic field according to a fusion algorithm to determine the IMU pose. Exemplary fusion algorithm may include a complementary filtering method, a Conjugate gradient filtering method, an extended Kalman filtering method, an unscented Kalman filtering method, or the like, or any combination thereof.

It should be noted that the above description is merely provided for the purposes of illustration, and not intended to limit the scope of the present disclosure. For persons having ordinary skills in the art, multiple variations or modifications may be made under the teachings of the present disclosure. However, those variations and modifications do not depart from the scope of the present disclosure. For example, one or more other optional operations (e.g., a storing operation) may be added elsewhere in the process 700. In the storing operation, the processing device 122 may store information and/or data (e.g., the IMU data) associated with the IMU in a storage device (e.g., the storage device 140) disclosed elsewhere in the present disclosure.

FIG. 8 is a flowchart illustrating an exemplary process 700 for determining a camera pose of a camera relative to a second coordinate system according to some embodiments of the present disclosure. In some embodiments, the process 800 may be implemented as a set of instructions (e.g., an application) stored in the storage ROM 230 or RAM 240. The processor 220 and/or the modules in FIG. 4 may execute the set of instructions, and when executing the instructions, the processor 220 and/or the modules may be configured to perform the process 800. The operations of the illustrated process presented below are intended to be illustrative. In some embodiments, the process 800 may be accomplished with one or more additional operations not described and/or without one or more of the operations herein discussed. Additionally, the order in which the operations of the process as illustrated in FIG. 8 and described below is not intended to be limiting.

In 810, the processing device 122 (e.g., the camera pose determining module 430, the interface circuits of the processor 220) may obtain camera data from the camera.

In some embodiments, when the autonomous vehicle is traveling straight, the camera may capture the camera data (e.g., videos or images) within the scope of the autonomous vehicle. The processing device 122 may obtain the camera data from the camera.

In 820, the processing device 122 (e.g., the camera pose determining module 430) may determine the second coordinate system based on the camera data.

In some embodiments, the processing device 122 may input the camera data into a 3D reconstruction method to obtain a 3D scenario. Exemplary 3D reconstruction method may include a Shape From Texture (SFT) method, a Shape From Shading method, a Multi-View Stereo (MVS) method, a Structure From Motion (SFM) method, a Time of Flight (ToF) method, a Structured Light method, a Moire schlieren method, or the like, or any combination thereof. In the 3D scenario, the processing device 122 may obtain a second ground normal vector and a second travelling direction of the camera. As shown in FIG. 6, the processing device 122 may use the second ground normal vector and the second travelling direction as two axes (e.g., the second ground normal vector as X₂ and the second travelling direction as Y₂ of the second coordinate system S₂ to determine the third axis (e.g., Z₂) of the second coordinate system S₂ according to a right-hand rule. The process or method for determining the second coordinate system may be found elsewhere in the present disclosure (e.g., FIG. 10 and the descriptions thereof).

In 830, the processing device 122 (e.g., the camera pose determining module 430) may determine the camera pose based on the camera data and the second coordinate system.

In some embodiments, the processing device 122 may determine the camera pose using a 3D reconstruction method. For example, the processing device 122 may input the camera data and/or the internal parameters of the camera into the SFM method. The SFM method may automatically restore a movement of the camera and 3D structure of a scene that the camera captured using the videos or images that the camera captured. For example, in the SFM method, a set of 2D feature points in the videos or images may be first tracked to obtain feature point trajectories over time. Then using the feature point trajectories over time, the location where the camera is and/or 3D locations of the feature points may be deduced. Using the location where the camera is and/or 3D locations of the feature points, a rotation matrix between the camera and the second coordinate system may be determined. The processing device 122 may determine the camera pose relative to the second coordinate system based on the rotation matrix.

It should be noted that the above description is merely provided for the purposes of illustration, and not intended to limit the scope of the present disclosure. For persons having ordinary skills in the art, multiple variations or modifications may be made under the teachings of the present disclosure. However, those variations and modifications do not depart from the scope of the present disclosure. For example, one or more other optional operations (e.g., a storing operation) may be added elsewhere in the process 800. In the storing operation, the processing device 122 may store information and/or data (e.g., the camera data) associated with the camera in a storage device (e.g., the storage device 140) disclosed elsewhere in the present disclosure.

FIG. 9 is a flowchart illustrating an exemplary process 900 for determining the second coordinate system according to some embodiments of the present disclosure. In some embodiments, the process 900 may be implemented as a set of instructions (e.g., an application) stored in the storage ROM 230 or RAM 240. The processor 220 and/or the modules in FIG. 4 may execute the set of instructions, and when executing the instructions, the processor 220 and/or the modules may be configured to perform the process 900. The operations of the illustrated process presented below are intended to be illustrative. In some embodiments, the process 900 may be accomplished with one or more additional operations not described and/or without one or more of the operations herein discussed. Additionally, the order in which the operations of the process as illustrated in FIG. 9 and described below is not intended to be limiting.

In 910, the processing device 122 (e.g., the camera pose determining module 430) may determine a second ground normal vector based on the camera data and a 3D reconstruction method.

In some embodiments, the processing device 122 may input the camera data into a 3D reconstruction method (e.g., an SFM method) to obtain a 3D scenario. The processing device 122 may obtain the ground normal vector in the 3D scenario as the second ground normal vector.

In 920, the processing device 122 (e.g., the camera pose determining module 430) may determine a second travelling direction of the camera based on the camera data.

The processing device 122 may obtain the travelling direction of the camera in the 3D scenario as the second travelling direction.

In 930, the processing device 122 (e.g., the camera pose determining module 430) may determine the second coordinate system based on the second ground normal vector and the second travelling direction of the camera.

In some embodiments, as shown in FIG. 6, the processing device 122 may use the second ground normal vector and the second travelling direction as two axes (e.g., the second ground normal vector as X₂ and the second travelling direction as Y₂) of the second coordinate system S₂ to determine the third axis (e.g., Z₂) of the second coordinate system S₂ according to a right-hand rule. The processing device 122 may determine the second coordinate system using the second ground normal vector, the second travelling direction, and the determined third axis as X₂, Y₂, and Z₂, respectively.

It should be noted that the above description is merely provided for the purposes of illustration, and not intended to limit the scope of the present disclosure. For persons having ordinary skills in the art, multiple variations or modifications may be made under the teachings of the present disclosure. However, those variations and modifications do not depart from the scope of the present disclosure. For example, one or more other optional operations (e.g., a storing operation) may be added elsewhere in the process 900. In the storing operation, the processing device 122 may store information and/or data (e.g., the camera data) associated with the camera in a storage device (e.g., the storage device 140) disclosed elsewhere in the present disclosure.

FIG. 10 is a flowchart illustrating an exemplary process 900 for determining a relative coordinate pose between the first coordinate system and the second coordinate system according to some embodiments of the present disclosure. In some embodiments, the process 1000 may be implemented as a set of instructions (e.g., an application) stored in the storage ROM 230 or RAM 240. The processor 220 and/or the modules in FIG. 4 may execute the set of instructions, and when executing the instructions, the processor 220 and/or the modules may be configured to perform the process 1000. The operations of the illustrated process presented below are intended to be illustrative. In some embodiments, the process 1000 may be accomplished with one or more additional operations not described and/or without one or more of the operations herein discussed. Additionally, the order in which the operations of the process as illustrated in FIG. 10 and described below is not intended to be limiting.

In 1010, the processing device 122 (e.g., the relative coordinate pose determining module 440) may align the first ground normal vector of the first coordinate system with the second ground normal vector of the second coordinate system.

In some embodiments, the processing device 122 may translate and/or rotate the first coordinate system towards the second coordinate system. The processing device 122 may align the first ground normal vector with the second ground normal vector after the translating and/or rotating. In some embodiments, the processing device 122 may record the translating and/or rotating in a form of an Euler angle, a Rotation matrix, an Orientation quaternion, or the like, or any combination thereof.

In 1020, the processing device 122 (e.g., the relative coordinate pose determining module 440) may align the first travelling direction of the IMU with the second travelling direction of the camera.

In some embodiments, after aligning the first ground normal vector with the second ground normal vector, the processing device 122 may further align the first travelling direction of the IMU with the second travelling direction of the camera around the aligned ground normal vector by rotating. In some embodiments, the processing device 122 may record the rotating in a form of an Euler angle, a Rotation matrix, an Orientation quaternion, or the like, or any combination thereof.

In 1030, the processing device 122 (e.g., the relative coordinate pose determining module 440) may determine the relative coordinate pose between the first coordinate system and the second coordinate system, which is described in FIG. 6.

In some embodiments, the processing device 122 may determine the relative coordinate pose based on the translating and/or rotating. In some embodiments, the relative coordinate pose may be represented as an Euler angle, a Rotation matrix, an Orientation quaternion, or the like, or any combination thereof.

It should be noted that the above description is merely provided for the purposes of illustration, and not intended to limit the scope of the present disclosure. For persons having ordinary skills in the art, multiple variations or modifications may be made under the teachings of the present disclosure. However, those variations and modifications do not depart from the scope of the present disclosure. For example, one or more other optional operations (e.g., a storing operation) may be added elsewhere in the process 1000. As another example, the processing device 122 may determine the relative coordinate pose between the first coordinate system and the second coordinate system based on a same reference coordinate system (e.g., the world coordinate system).

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electromagnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software-only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

1. A system for calibrating an inertial measurement unit (IMU) and a camera of an autonomous vehicle, comprising:
at least one storage medium including a set of instructions for calibrating the IMU and the camera; and
at least one processor in communication with the storage medium, wherein when executing the set of instructions, the at least one processor is directed to:
obtain a track of the autonomous vehicle traveling straight;
determine an IMU pose of the IMU relative to a first coordinate system;
determine a camera pose of the camera relative to a second coordinate system;
determine a relative coordinate pose between the first coordinate system and the second coordinate system; and
determine a relative pose between the camera and the IMU based on the IMU pose, the camera pose, and the relative coordinate pose.

2. The system of claim 1, wherein the at least one processor is further directed to:
determine the first coordinate system based on the track of the autonomous vehicle.

3. The system of claim 2, wherein to determine the IMU pose, the at least one processor is further directed to:
obtain IMU data from the IMU; and
determine the IMU pose based on the IMU data and the first coordinate system.

4. The system of claim 1, wherein the at least one processor is further directed to:
obtain camera data from the camera; and
determine the second coordinate system based on camera data.

5. The system of claim 4, wherein to determine the camera pose, the at least one processor is further directed to:
determine the camera pose based on the camera data and the second coordinate system.

6. The system of claim 4, wherein to determine the second coordinate system, the at least one processor is further directed to:
determine a second ground normal vector based on the camera data and a 3D reconstruction method;
determine a second travelling direction of the camera based on the camera data; and
determine the second coordinate system based on the second ground normal vector and the second travelling direction of the camera.

7. The system of claim 6, wherein the 3D reconstruction method is a Structure from Motion (SFM) method.

8. The system of claim 1, wherein to determine the relative coordinate pose, the at least one processor is further directed to:
align a first ground normal vector of the first coordinate system with the second ground normal vector of the second coordinate system;
align a first travelling direction of the IMU with the second travelling direction of the camera; and
determine the relative coordinate pose between the first coordinate system and the second coordinate system.

9. A method for calibrating an inertial measurement unit (IMU) and a camera of an autonomous vehicle, implemented on a computing device including at least one storage medium including a set of instructions, and at least one processor in communication with the storage medium, the method comprising:
obtaining a track of the autonomous vehicle traveling straight;
determining an IMU pose of the IMU relative to a first coordinate system;
determining a camera pose of the camera relative to a second coordinate system;
determining a relative coordinate pose between the first coordinate system and the second coordinate system; and
determining a relative pose between the camera and the IMU based on the IMU pose, the camera pose, and the relative coordinate pose.

10. The method of claim 9, further comprising:
determining the first coordinate system based on the track of the autonomous vehicle.

11. The method of claim 10, wherein the determining the IMU pose further comprises:
obtaining IMU data from the IMU; and
determining the IMU pose based on the IMU data and the first coordinate system.

12. The method of claim 9, further comprising:
obtaining camera data from the camera; and
determining the second coordinate system based on camera data.

13. The method of claim 12, wherein the determining the camera pose comprises:
determining the camera pose based on the camera data and the second coordinate system.

14. The method of claim 12, wherein the determining the second coordinate system comprises:
determining a second ground normal vector based on the camera data and a 3D reconstruction method;
determining a second travelling direction of the camera based on the camera data; and
determining the second coordinate system based on the second ground normal vector and the second travelling direction of the camera.

15. The method of claim 14, wherein the 3D reconstruction method is a Structure from Motion (SFM) method.

16. The method of claim 9, wherein the determining the relative coordinate pose comprises:
aligning a first ground normal vector of the first coordinate system with the second ground normal vector of the second coordinate system;
aligning a first travelling direction of the IMU with the second travelling direction of the camera; and
determining the relative coordinate pose between the first coordinate system and the second coordinate system.

17. A non-transitory readable medium, comprising at least one set of instructions for calibrating an inertial measurement unit (IMU) and a camera of an autonomous vehicle, wherein when executed by at least one processor of an electrical device, the at least one set of instructions directs the at least one processor to perform a method, the method comprising:
obtaining a track of the autonomous vehicle traveling straight;
determining an IMU pose of the IMU relative to a first coordinate system;
determining a camera pose of the camera relative to a second coordinate system;
determining a relative coordinate pose between the first coordinate system and the second coordinate system; and
determining a relative pose between the camera and the IMU based on the IMU pose, the camera pose, and the relative coordinate pose.

18. The non-transitory readable medium of claim 17, wherein the method further comprises:
determining the first coordinate system based on the track of the autonomous vehicle.

19. The non-transitory readable medium of claim 18, wherein the determining the IMU pose further comprises:
obtaining IMU data from the IMU; and
determining the IMU pose based on the IMU data and the first coordinate system.

20. (canceled)

21. The non-transitory readable medium of claim 17, wherein the method further comprises:
obtain camera data from the camera; and
determine the second coordinate system based on camera data.
